(19) United States
(12) Patent Application Publication
(10) Pub. No.: US 2025/0345758 A1
(43) Pub. Date: Nov. 13, 2025

(54) SYSTEM FOR PRODUCING AN OIL-IN-WATER EMULSION

(71) Applicants: Quadrise International Limited, London (GB); Nouryon Chemicals International B.V., Arnhem (NE)

(72) Inventors: Jason Victor MILES, London (GB); Patrick BRUNELLE, London (GB); Dennis SELSE, Myggenas (SE)

(21) Appl. No.: 18/860,438

(22) PCT Filed: Apr. 26, 2023
(86) PCT No.: PCT/EP2023/061021

§ 371 Date: Oct. 25, 2024

(30) Foreign Application Priority Data
Apr. 26, 2022 (GB) 2206071.9

(51) Int. Cl. B01F 23/41; B01F 23/40; B01F 33/502; B01F 101/00

(52) U.S. Cl. CPC B01F 23/4145; B01F 23/49; B01F 33/502; B01F 2101/505

(57) ABSTRACT

A system for producing an oil-in-water emulsion; the system comprising: a first input for coupling to a source of fuel on a vehicle; a second input for coupling to a source of water; a third input for coupling to a source of first additive; a mixing section for mixing the water and the first additive to form an aqueous phase; and a blender for blending the aqueous phase with the fuel to form the oil-in-water emulsion; wherein the first input is coupled to the blender; the second input and the third input are coupled to the mixing section; and the mixing section is coupled to the blender.

### TECHNICAL FIELD

The invention relates to systems for producing an oil-in-water emulsion, in particular an oil in water emulsion that can be used as a fuel for a vehicle. The invention also relates to uses of a system to produce an oil-in-water emulsion, a process of preparing an oil-in-water emulsion using a system, and a vehicle comprising a system.

### BACKGROUND OF THE INVENTION

Conventional heavy fuel oils are normally produced by blending viscous refinery residues with higher value distillate fuels to provide the lower viscosity characteristics required for acceptable fuel handling and combustion performance. Direct use of high viscosity refinery residues requires high-temperature storage and handling that limits and complicates their potential use, and consequently lowers their value. As an alternative to blending refinery residues for fuel oil production, further processing (e.g. coking, hydrocracking, etc.) of the residue can be applied at the refinery to yield additional distillate fuels. This strategy requires large capital investments to be made by the oil refinery, produces some lower value products, generates difficult to market by-products, and results in an increase of emissions (including greenhouse and acid gases), all of which can serve to limit the economic advantage of this approach. Furthermore, the burning of conventional fuel oils is linked to key environmental problems including the emission of black Soot, NOx & SOx.

In contrast to conventional blending or further processing of heavy fuel oils, oil-in-water emulsions may be used. WO 2017/077302 A2 and WO 2018/206963 A1 describe oil-in-water emulsions that are prepared on land, i.e. not on a vehicle or at sea. These emulsions require specific properties because they are made in large land based refineries and are then held in storage tanks for extended periods of time. For example, such oil-in-water emulsions have a specific static and dynamic stability. This is necessary because such emulsions may be stored in multiple locations over a period of time and as such are required to have characteristics that allow them to be stored, pumped and transported at varying temperatures without negatively affecting the emulsions' properties. The systems that produce these emulsions are necessarily very large to allow for large input and output volumes.

### SUMMARY OF THE INVENTION

In some aspects, the invention relates to a system for producing an oil-in-water emulsion; the system comprising a first input for coupling to a source of fuel on a vehicle; a second input for coupling to a source of water; a third input for coupling to a source of first additive; a mixing section for mixing the water and the first additive to form an aqueous phase; and a blender for blending the aqueous phase with the fuel to form the oil in water emulsion; wherein the first input is coupled to the blender; the second input and the third input are coupled to the mixing section; and the mixing section is coupled to the blender.

In some aspects, the invention relates to a system for producing an oil-in-water emulsion; the system comprising a first input configured to accept a fuel source with a viscosity of less than about 1000 cP at 50° C. and 100 s⁻¹; a second input for coupling to a source of water; a third input for coupling to a source of first additive; a mixing section for mixing the water and the first additive to form an aqueous phase; and a blender for blending the aqueous phase with the fuel to form the oil in water emulsion; wherein the first input is coupled to the blender; the second input and the third input are coupled to the mixing section; and the mixing section is coupled to the blender.

In some embodiments, the fuel comprises a marine fuel, biofuel, bio-oil, residual fuel oil, and/or distillate fuel oil.

In some embodiments, the first additive is one or more first additives.

In some embodiments, the first input comprises a first auxiliary output for coupling to the source of fuel on the vehicle; wherein the second input comprises a second auxiliary output for coupling to the source of water; and/or wherein the third input comprises a third auxiliary output for coupling to the source of first additive.

In some embodiments, the mixing section comprises a mixer, optionally an inline mixer.

In some embodiments: (i) the mixing section is coupled directly to the blender; or (ii) the system comprises an intermediate section and the mixing section is coupled to the intermediate section and the intermediate section is coupled to the blender.

In some embodiments: (i) the first input is coupled directly to the blender; or (ii) the system comprises an intermediate section and the first input is coupled to the intermediate section and the intermediate section is coupled to the blender.

In some embodiments, the intermediate section is configured to combine the fuel from the first input and the aqueous phase from the mixing section at a combining point; optionally wherein the distance from the combining point to the blender is less than about 0.1 m; optionally less than about 0.05 m or less than about 0.01 m

In some embodiments, the blender is a milling machine, a mixing machine, or a homogeniser.

In some embodiments, the system comprises an output for coupling to an engine of a vehicle; optionally wherein the output is an output of the blender or is coupled to an output of the blender. In some embodiments: (i) the output is for coupling directly to the engine; or (ii) the system comprises an intermediate output section for coupling to the engine of a vehicle and the output is coupled to the intermediate output section. In some embodiments, the intermediate output section comprises a first container having an internal volume from about 10 litres to about 40000 litres.

In some embodiments, the first container comprises a first container output for coupling to the engine of a vehicle; optionally wherein the first container output is coupled to one or more of the intermediate section, the blender, the output, the first container, and/or the intermediate output section.

In some embodiments, the intermediate output section comprises a second container having an internal volume from about 1 litre to about 100 litres; optionally wherein the second container comprises a second container output that is coupled to one or more of the intermediate section, the blender, the output, and/or the intermediate output section.

In some embodiments, the intermediate output section comprises one or more flow directors that are configured to allow a flow of fluid from the blender to be provided to the first container and/or the second container.

In some embodiments, the system comprises a fourth input for coupling to a source of second additive, and coupled to the mixing section.

In some embodiments, the system comprises one or more heaters. In some embodiments, the system comprises one or more viscometers; optionally the output or the intermediate output section comprises a viscometer. In some embodiments, the system comprises one or more particle size analysers; optionally the output or the intermediate output section comprises a particle size analyser.

In some embodiments, the system comprises one or more controllers configured to receive an output from one or more of a flow regulator, blender, mixer, pump, heater, viscometer, and/or particle size analyser and output a controlling signal to one or more of a flow regulator, blender, mixer, pump, heater, viscometer, and/or particle size analyser.

In some embodiments, the vehicle is a vessel, optionally a marine vessel.

In some embodiments, the system is configured to form an oil-in-water emulsion. In some embodiments, the system is not configured to form a water-in-oil emulsion.

In some embodiments, the first input is coupled to a source of fuel on a vehicle; the second input is coupled to a source of water (such as on a vehicle); and/or the third input is coupled to a source of first additive (such as on a vehicle).

In some aspects, the invention relates to a vehicle comprising the system described herein, optionally wherein the vehicle is a vessel.

In some aspects, the invention relates to a use of a system described herein to produce an oil-in-water emulsion on a vehicle, optionally wherein the vehicle is a vessel.

In some aspects, the invention relates to a process of forming an oil-in-water emulsion using the system described herein.

### BRIEF DESCRIPTION OF THE DRAWINGS

The present invention will now be described with reference to the accompanying drawings, in which:

FIG. 1 is a schematic of a system for producing an oil-in-water emulsion according to an embodiment as described herein.

FIG. 2 is a schematic of a system for producing an oil-in-water emulsion according to an embodiment as described herein.

### DETAILED DESCRIPTION

The invention relates to systems for producing an oil-in-water emulsion, in particular an oil-in-water emulsion that can be used as a fuel for a vehicle. The invention also relates to uses of a system to produce an oil-in-water emulsion, a process of preparing an oil-in-water emulsion using a system, and a vehicle comprising a system.

In a first aspect, the invention relates to a system for producing an oil-in-water emulsion; the system comprising: a first input for coupling to a source of fuel on a vehicle; a second input for coupling to a source of water; a third input for coupling to a source of first additive; a mixing section for mixing the water and the first additive to form an aqueous phase; and a blender for blending the aqueous phase with the fuel to form the oil-in-water emulsion; wherein the first input is coupled to the blender; the second input and the third input are coupled to the mixing section; and the mixing section is coupled to the blender.

In a second aspect, the invention relates to system for producing an oil-in-water emulsion; the system comprising a first input configured to accept a fuel source with a viscosity of less than about 1000 cP at 50° C.; a second input for coupling to a source of water; a third input for coupling to a source of first additive; a mixing section for mixing the water and the first additive to form an aqueous phase; and a blender for blending the aqueous phase with the fuel to form the oil-in-water emulsion; wherein the first input is coupled to the blender; the second input and the third input are coupled to the mixing section; and the mixing section is coupled to the blender.

In some embodiments, the vehicle is a vessel. For example, the vehicle is a marine vessel. In some embodiments, the system is for use on a vehicle. In some embodiments, the system is configured for use on vehicle. In some embodiments, the system is for producing an oil-in-water emulsion on a vehicle.

The present invention allows for on board production of an oil-in-water emulsion that can be used to power the engines of a vehicle. The present invention can be used in vehicles where free space is limited, such as on a vessel (for example, a marine vessel).

The invention may be fitted to a vessel after the initial manufacturing of the vessel is completed. For example, the invention may be retrofitted to a vessel. In such circumstances, space is very limited. The present invention relates to a system that can be used in such confined spaces.

### Pre-Blender Coupling Relationship

In some embodiments, the first input is a tubular member with an internal diameter of from about 0.01 m to about 0.5 m; optionally from about 0.01 m to about 0.2 m; preferably from about 0.01 m to about 0.15 m.

In some embodiments, the first input comprises an end for coupling to the source of fuel on a vehicle. In some embodiments, the first input comprises a first attachment for coupling to the source of fuel on a vehicle, wherein the first attachment has a diameter of from about 0.01 m to about 0.5 m; optionally from about 0.01 m to about 0.2 m; preferably from about 0.01 m to about 0.15 m.

In some embodiments, the first input comprises an end for coupling to the blender, for example an input of the blender. In some embodiments, the first input is coupled directly to the blender. For example, the first input comprises an end for coupling directly to the blender. In some embodiments, the first input comprises a first attachment for coupling to the blender, wherein the first attachment has a diameter of from about 0.01 m to about 0.5 m; optionally from about 0.01 m to about 0.2 m; preferably from about 0.01 m to about 0.15 m.

In alternative embodiments, the system comprises an intermediate section and the first input is coupled to the intermediate section and the intermediate section is coupled to the blender. The intermediate section is between the first input and the blender. The intermediate section may be a tubular section or a non-tubular section. For example, the intermediate section may be a pipe or container, for example a vessel or tank.

In some embodiments, the second input is a tubular member with an internal diameter of from about 0.01 m to about 0.5 m; optionally from about 0.01 m to about 0.2 m; preferably from about 0.01 m to about 0.15 m. For example, the second input has an internal diameter of from about 0.01 m to about 0.1 m.

In some embodiments, the second input comprises an end for coupling to the source of water. In some embodiments, the second input comprises a second attachment for coupling to the source of water, wherein the second attachment has a diameter of from about 0.01 m to about 0.5 m; optionally from about 0.01 m to about 0.2 m; preferably from about 0.01 m to about 0.15 m. For example, the second attachment has a diameter of from about 0.01 m to about 0.1 m.

In some embodiments, the second input comprises an end for coupling to the mixing section, for example an input of the mixing section. In some embodiments, the second input is coupled directly to the mixing section. For example, the second input comprises an end for coupling directly to the mixing section. In some embodiments, the second input comprises a second attachment for coupling to the mixing section, wherein the second attachment has a diameter of from about 0.01 m to about 0.5 m; optionally from about 0.01 m to about 0.2 m; preferably from about 0.01 m to about 0.15 m. For example, the second attachment has a diameter of from about 0.01 m to about 0.1 m.

In some embodiments, the third input is a tubular member with an internal diameter of from about 0.01 m to about 0.05 m, optionally from about 0.01 m to about 0.04 m;

preferably from about 0.01 m to about 0.03 m.

In some embodiments, the third input comprises an end for coupling to the source of first additive. In some embodiments, the third input comprises a second attachment for coupling to the source of first additive, wherein the third attachment has a diameter of from about 0.01 m to about 0.05 m, optionally from about 0.01 m to about 0.04 m; preferably from about 0.01 m to about 0.03 m.

In some embodiments, the third input comprises an end for coupling to the mixing section, for example an input of the mixing section. In some embodiments, the third input is coupled directly to the mixing section. For example, the third input comprises an end for coupling directly to the mixing section. In some embodiments, the third input comprises a third attachment for coupling to the mixing section, wherein the third attachment has a diameter of from about 0.01 m to about 0.05 m, optionally from about 0.01 m to about 0.04 m; preferably from about 0.01 m to about 0.03 m.

### Mixing Section and Intermediate Section

The mixing section comprises an end (for example an input) for coupling to the second input (for example the end of the second input for coupling to the mixing section). The mixing section comprises an end (for example and output) for coupling to the blender (for example an input of the blender). The mixing section may be any mixing section capable of mixing the first additive with the water. For example, the mixing section may be a pipe or container, for example a vessel or tank.

The mixing section is for mixing water from the source of water with first additive from the source of first additive to form an aqueous phase. For example, the aqueous phase is a homogenous aqueous phase. The mixing section may comprise a mixer, for example an inline mixer. The mixer may be static mixer or a dynamic mixer. For example, the static mixer may be a static inline mixer. For example, the dynamic mixer may be a dynamic inline mixer. In some embodiments, the mixer may be a Denimo Tech A/S colloidal mill, a ENH A/S colloidal mill, a Dalworth colloidal mill, or a IKA colloidal mill. When the mixing section comprises a mixer, the total volume of the mixing section can be reduced as the total dwell time in the mixing section can be reduced. When the mixing section comprises a dynamic mixer, the total volume of the mixing section can be further reduced as the total dwell time in the mixing section can be further reduced.

The mixing section is coupled to the blender. In some embodiments, the mixing section comprises an end (for example an output) for coupling to the blender (for example an input of the blender).

In some embodiments, the mixing section is coupled directly to the blender. For example, the mixing section comprises an end for coupling directly to the blender. In some embodiments, the mixing section comprises an attachment for coupling to the blender. In alternative embodiments, the system comprises an intermediate section and the mixing section is coupled to the intermediate section and the intermediate section is coupled to the blender. The intermediate section is between the mixing section and the blender.

The intermediate section is configured to allow the fuel from the first input to be combined with the aqueous phase from the mixing section before the resulting fluid is provided to the blender. The resulting fluid is a combination of the fuel and the aqueous phase. The intermediate section may be a tubular section or it may be a non-tubular section. For example, the intermediate section may be a pipe or container, for example a vessel or tank.

In some embodiments, the first input and the mixing section are coupled to the (same) intermediate section. For example, the first input and the mixing section are coupled to the intermediate section at a coupling point. Alternatively, the first input is coupled to the intermediate section at a first coupling point and the mixing section is coupled to the intermediate section at a second coupling point. In both cases, the fuel from the first input and the aqueous phase from the mixing section are combined in the intermediate section. For example, the intermediate section is configured to combine the fuel from the first input and the aqueous phase from the mixing section at a combining point. The intermediate section may be configured to allow a given volume of the fuel from the first input to combine with a given volume of the aqueous phase from the mixing section for a specific time period before providing the resulting combined fluid to the blender. Said time period may be less than about 60 seconds; optionally less than about 30 seconds; preferably less than about 10 seconds. In some embodiments, a distance from a combining point to the blender is less than about 0.1 m; optionally less than about 0.05 m; preferably less than about 0.01 m. In such arrangements, the fuel and the aqueous phase are combined such that they are suitable for blending by the blender to form a preferred oil-in-water emulsion.

### Blender

The blender is coupled to the first input and the mixing section. For example, the blender is coupled directly to the first input and the mixing section. For example, the blender is coupled to the intermediate section.

The blender is for blending the aqueous phase with the fuel to form the oil-in-water emulsion. For example, the blender has a first input for accepting the fuel from the first input and a second input for accepting the aqueous phase from the mixing section. Alternatively, the blender has an input for accepting the fuel and the aqueous phase from the intermediate section.

In some embodiments, the blender is configured to blend the aqueous phase with the fuel to form the oil-in-water emulsion. In some embodiments, the blender is not configured to form a water-in-oil emulsion.

The blender may be any blender that blends the aqueous phase with the fuel to form the oil-in-water emulsion. In some embodiments, the blender is a milling machine, a mixing machine, or a homogeniser. For example, the blender may be a high shear blender, such as a high shear static blender or a high velocity rotating mixer. In some embodiments, the blender is a homogeniser. In some embodiments, the blender is a colloid mill.

### Output

In some embodiments, the system comprises an output for coupling to an engine of a vehicle. For example, the output is an output of the blender or is coupled to an output of the blender. In some embodiments, the output is for coupling directly to the engine. In some embodiments, the system comprises an intermediate output section for coupling to the engine of a vehicle and the output is coupled to the intermediate output section.

The intermediate output section may comprise a first container. The first container is for storing the oil-in-water emulsion formed by the blender. For example, the first container has a volume sufficient to store an amount of oil-in-water emulsion that allows the engine of the vehicle to operate for between about 5 and about 60 minutes at 100% of its design capacity (for example at its maximum continuous rating). Such arrangements allow the system to operate efficiently even when a part/section of the system needs to be shutdown or turned off. For example, if a section malfunctions, needs repair or requires bringing up to a specific operational speed or capacity.

The first container may have an internal volume from about 10 to about 40000 litres. The volume of the first container may correspond to the engine of the vehicle. For example, the volume of the first container may correspond to a specific engine capacity or engine output (MW). As such, the system can be tuned for compatibility with a specific vehicle and/or engine.

An engine of a vehicle (for example a marine vessel) may have a maximum continuous rating (MCR) engine capacity of between about 0.1 and about 100 megawatts (MW). In vehicles having an engine with lower MCR engine capacity, the internal volume of the first container may be lower than in a vehicle with an engine with a higher MCR engine capacity. For example, a typical high speed four-stroke engine may have an MCR engine capacity of about 0.5 MW. For example, a typical medium speed four-stroke engine may have an MCR engine capacity of about 13 MW. For example, a typical slow speed two-stroke engine may have an MCR engine capacity of about 45 MW.

The skilled person may determine the size of the first container based on the number of engines to be provided with the oil-in-water emulsion; the MCR engine capacity of the engine(s); and the amount of redundancy to be built into the system. In this regard, the “redundancy” refers to the amount of time that the engine should be able to be powered for if the system does not produce additional oil-in-water emulsion (if for example the blender failed and did not produce oil-in-water emulsion for a period of time). This redundancy can be measure in minutes.

In some embodiments, the internal volume of the first container may be determined using Table 1.

TABLE 1

| | | Typical High | Typical Medium | Typical Slow |
|---|---|---|---|---|
| | | Speed Four- | Speed Four- | Speed Two- |
| | Redundancy | Stroke Engine | Stroke Engine | Stroke Engine |
| | (minutes) | (MCR: 0.5) | (MCR: 13) | (MCR: 45) |
| First | 5 | 40 | 26 | 23 |
| Container | 60 | 460 | 309 | 275 |
| Size (L/MW) | | | | |
| First | 15 | 60 | 1020 | 3180 |
| Container | | | | |
| Size (L) | | | | |

*The values in the table have been rounded up at the relevant calculation points.

In some embodiments, the first container has an internal volume from about 10 litres to about 40000 litres; optionally between about 10 litres and 20000 litres; between about 10 litres and about 10000 litres; between about 10 litres and about 5000 litres; between about 10 litres and about 1000 litres; between about 10 litres and about 500 litres; or between about 10 litres and about 250 litres.

In some embodiments, the first container has an internal volume from about 10 litres to about 40000 litres; optionally between about 100 litres and 30000 litres; between about 100 litres and about 20000 litres; between about 200 litres and about 20000 litres; or between about 500 litres and about 20000 litres.

In some embodiments, the first container has an internal volume from about 10 litres to about 40000 litres; optionally between about 100 litres and 40000 litres; between about 1000 litres and about 40000 litres; between about 5000 litres and about 40000 litres; between about 10000 litres and about 40000 litres; or between about 20000 litres and about 40000 litres.

In some embodiments, the internal volume of the first container described herein is multiplied by a factor selected from about 1 to about 2; for example 1.1, 1.2, 1.3, 1.4, 1.5 or 1.6. Preferably, the internal volume of the first container described herein is multiplied by a factor of 1.1 or 1.2. In such embodiments, the first container can contain a volume of oil-in-water emulsion sufficient to be supplied to additional engines. For example if the vehicle comprises two or more main engines and/or one or more auxiliary engines.

The first container may comprise a first container input for accepting the oil-in-water emulsion formed by the blender. The first container may comprise a first container output for coupling to the engine of a vehicle. The first container output may also be coupled to one or more of the intermediate section, the blender, the output, and/or the intermediate output section. Preferably, the first container output is coupled to one or more of the intermediate section, the blender, and/or the output. For example, the first container output is coupled to the intermediate section or the blender; preferably the intermediate section. Such arrangements allow for the oil-in-water emulsion to be provided to the one or more of the intermediate section, the blender, the output, and/or the intermediate output section when the oil-in-water emulsion in the first container is not provided to the engine. This allows the system to be compact and allows the system to operate with very little turn down. This allows the operator of the system to keep the blender operating at high turnover with little turn down for extended periods of time, even when the engine of the vehicle does not require the oil-in-water emulsion (thereby reducing inefficiencies associated with changing the operational capacity/speed of the blender). Additionally, this allows for oil-in-water emulsion in the first container to be mixed with fluid from an earlier stage in the process, thereby ensuring that the oil-in-water emulsion provided to the engine is of a consistent quality/has consistent characteristics over time.

Alternatively, the first container may comprise an additional first container output that is coupled to one or more of the intermediate section, the blender, the output, and/or the intermediate output section.

The intermediate output section may comprise a second container. The second container may have an internal volume from about 1 to about 1000 litres; optionally between about 1 and 500 litres; for example between 1 and 100 litres. The second container is for storing a fluid produced by the blender. For example, the second container has a volume sufficient to store the amount of fluid required in a start-up operation of the blender. Alternatively, the first container has a volume sufficient to store an amount of oil-in-water emulsion that is produced by the blender but that has characteristics that the engine of the vehicle does not need to operate on at a specific time. Such arrangements, allow the system to provide an optimal oil-in-water emulsion over extended period of time.

The intermediate output section may comprise one or more flow directors that are configured to allow a flow of fluid from the blender to be provided to the first container and/or the second container. Each flow director is coupled to the output and one or each of the first container and second container. Each flow director may individually be a valve, such as a switching valve. Each flow director may individually be one or more flow regulators.

In some embodiments, the second container comprises a second container output that is coupled to one or more of the intermediate section, the blender, the output, the first container, and/or the intermediate output section. Preferably, the second container comprises a second container output that is coupled to one or more of the intermediate section, the blender, and/or the output. The second container output may alternatively be coupled to an exit port, for example, for removal of the fluid in the second container from the system for storage and later disposal. For example, the second container output may be coupled to a storage tank.

In some embodiments, the intermediate output section comprises one or more intermediate output section valves, one or more intermediate output section flow regulators and/or one or more intermediate output section pumps. For example, the intermediate output section comprises an intermediate output section pump and/or an intermediate output section flow regulator between the first container output and/or additional first container output and one or more of the intermediate section, the blender, the output, and/or the intermediate output section. Preferably, the intermediate output section comprises an intermediate output section pump and/or an intermediate output section flow regulator between the first container output and/or additional first container output and one or more of the intermediate section, the blender, and/or the output.

In some embodiments, the intermediate output section comprises an intermediate output section pump and/or an intermediate output section flow regulator between the second container output and one or more of the intermediate section, the blender, the output, the first container and/or the intermediate output section. Preferably, the intermediate output section comprises an intermediate output section pump and/or an intermediate output section flow regulator between the second container output and one or more of the intermediate section, the blender, and/or the output.

### MSAR Fuel Unit

In some embodiments, the system comprises an output modulation section. The output modulation section may be coupled to one or more of the blender, the output and/or the intermediate output section and is for coupling to an engine of a vehicle. For example, the output modulation section is coupled to the first container/additional first container output and is for coupling to an engine of a vehicle. The output modulation section may be between the blender and the engine of a vehicle. For example, the output modulation section may be between the first container/additional first container output and the engine of a vehicle.

The output modulation section is configured to modulate one or more properties of the oil-in-water emulsion. The output modulation section therefore allows the oil-in-water emulsion to be tuned for use in a specific engine on a vehicle. This is important for vehicles that have more than one engine where each engine requires a fuel with different properties. The output modulation section also allows a user of the system to tune the properties of the oil-in-water emulsion so that the oil-in-water emulsion is particularly suitable for a specific engine of a vehicle.

The output modulation section may comprise, an input, one or more pumps, one or more flow regulators, one or more containers, one or heaters and/or one or more outputs. For example, the output modulation section comprises an input, a flow regulator, a container, a pump, a heater and an output. Preferably, the input is coupled to the output of the first container/additional first container output and the flow regulator; the flow regulator is coupled to the input and the container; the container is coupled to the flow regulator and the pump; the pump is coupled to the container and the heater; the heater is coupled to the container and the output; and the output is coupled to the heater and is for coupling to an engine of a vehicle. Additionally, the output modulation section may comprise a pump between the input and the flow regulator. In some embodiments, the output modulation section does not comprise the flow regulator coupled to the input and the container. In such embodiments, the container may comprises a flow regulator. Said flow regulator may comprise a float switch.

In some embodiments, the container of the output modulation section has volume of from about 1 to about 100 litres; optionally between about 1 and 50 litres; for example between 1 and 10 litres. In some embodiments, the container is a de-aeration tank.

In some embodiments, the output modulation section has an additional input that is for coupling to an output of an engine on a vehicle. The additional input may be coupled to the container. In such arrangements, it is possible for fluid in an engine of a vehicle to be provided to the output modulation section and thereby avoiding mixing of this fluid with other fluid types/sources on a vehicle.

### First Input Components

In some embodiments, the first input comprises one or more first flow regulators, preferably between the source of fuel on a vehicle and the blender. For example, the first input may comprise one or more first flow regulators between an end of the first input for coupling to the source of fuel on a vehicle and the blender. For example, the first input may comprise 1, 2, 3 or more first flow regulators. Preferably, the first input comprises 1 or 2 first flow regulators. For example, the first input comprises 1 first flow regulator. For example, a first of the one or more first flow regulators may comprise a valve and a second of the one or more first flow regulators may comprise a variable frequency drive pump.

In some embodiments, the first input comprises one or more first pumps, preferably between the source of fuel on a vehicle and the blender. For example, the first input may comprise one or more first pumps between an end of the first input for coupling to the source of fuel on a vehicle and the blender. For example, the first input may comprise 1, 2, 3 or more first pumps. Preferably, the first input comprises 1 or 2 first pumps. For example, the first input comprises 1 first pump.

In some embodiments, one of the one or more first pumps is between an end of the first input for coupling to the source of fuel on a vehicle and one of the one or more first flow regulators. For example, the first input comprises a first pump between an end of the first input for coupling to the source of fuel on a vehicle and a first flow regulator. The first flow regulator being between the first pump and the blender.

In some embodiments, the one or more first pumps is between a first of the one or more first flow regulators and a second of the one or more first flow regulators. In some embodiments, the one or more first pumps is between a first of the one or more first flow regulators and the blender. For example, a first of the one or more first flow regulators may comprise a valve and a first pump may comprise a variable frequency drive pump.

In some embodiments, the first input comprises a first auxiliary output for coupling to the source of fuel on the vehicle. For example, the first auxiliary output comprises a tubular member for coupling to the source of fuel on a vehicle. The first auxiliary output allows the fuel from the source of fuel on a vehicle that has entered the first input to be provided back to the source of fuel on a vehicle. Such an arrangement reduces the need for additional tanks for storing fuel that has entered the first input when it is not provided to the blender. The first auxiliary output may be positioned anywhere in the system that allows for it provide said purpose. For example, the first auxiliary output may be between one of the one or more first pumps and one of the one or more first flow regulators.

In some embodiments, the first input comprises a first pump between a first first flow regulator and a second first flow regulator. The first first flow regulator may be between an end of the first input for coupling to the source of fuel on a vehicle and the first pump. The second first flow regulator may be between the first pump and the blender. The first auxiliary output may be between the first pump and the second first flow regulator.

### Second Input Components

In some embodiments, the second input comprises one or more second flow regulators, preferably between the source of water and the mixing section. For example, the second input may comprise one or more second flow regulators between an end of the second input for coupling to the source of water and the mixing section. For example, the second input may comprise 1, 2, 3 or more second flow regulators. Preferably, the second input comprises 1 or 2 second flow regulators. For example, the second input comprises 1 second flow regulator. For example, a first of the one or more second flow regulators may comprise a valve and a second of the one or more second flow regulators may comprise a variable frequency drive pump.

In some embodiments, the second input comprises one or more second pumps, preferably between the source of water and the mixing section. For example, the second input may comprise one or more second pumps between an end of the second input for coupling to the source of water and the mixing section. For example, the second input may comprise 1, 2, 3 or more second pumps. Preferably, the second input comprises 1 or 2 second pumps. For example, the second input comprises 1 second pump.

In some embodiments, one of the one or more second pumps is between an end of the second input for coupling to the source of water and one of the one or more second flow regulators. For example, the second input comprises a second pump between an end of the second input for coupling to the source of water and a second flow regulator. The second flow regulator being between the second pump and the mixing section.

In some embodiments, the one or more second pumps is between a first of the one or more second flow regulators and a second of the one or more second flow regulators. In some embodiments, the one or more second pumps is between a first of the one or more second flow regulators and the mixing section. For example, a first of the one or more second flow regulators may comprise a valve and a second pump may comprise a variable frequency drive pump.

In some embodiments, the second input comprises a second auxiliary output for coupling to the source of water on the vehicle. For example, the second auxiliary output comprises a tubular member for coupling to the source of water. The second auxiliary output allows the water from the source of water that has entered the second input to be provided back to the source of water. Such an arrangement reduces the need for additional tanks for storing water that has entered the second input when it is not provided to the mixing section. The second auxiliary output may be positioned anywhere in the system that allows for it provide said purpose. For example, the second auxiliary output may be between one of the one or more second pumps and one of the one or more second flow regulators. For example, the second auxiliary output may between the second pump and the second flow regulator.

In some embodiments, the second input comprises a second pump between a first second flow regulator and a second second flow regulator. The first second flow regulator may be between an end of the second input for coupling to the source of water and the second pump. The second second flow regulator may be between the second pump and the mixing section. The second auxiliary output may be between the second pump and the second second flow regulator.

### Third Input Components

In some embodiments, the third input comprises one or more third flow regulators, preferably between the source of first additive and the mixing section. For example, the third input may comprise one or more third flow regulators between an end of the third input for coupling to the source of first additive and the mixing section. For example, the third input may comprise 1, 2, 3 or more third flow regulators. Preferably, the third input comprises 1 or 2 third flow regulators. For example, the third input comprises 1 third flow regulator. For example, a first of the one or more third flow regulators may comprise a valve and a second of the one or more third flow regulators may comprise a variable frequency drive pump.

In some embodiments, the third input comprises one or more third pumps, preferably between the source of a first additive and the mixing section. For example, the third input may comprise one or more third pumps between an end of the third input for coupling to the source of first additive and the mixing section. For example, the third input may comprise 1, 2, 3 or more third pumps. Preferably, the third input comprises 1 or 2 third pumps. For example, the third input comprises 1 third pump.

In some embodiments, one of the one or more third pumps is between an end of the third input for coupling to the source of a first additive and one of the one or more third flow regulators. For example, the third input comprises a third pump between an end of the third input for coupling to the source of first additive and a third flow regulator. The third flow regulator being between the third pump and the mixing section.

In some embodiments, the one or more third pumps is between a first of the one or more third flow regulators and a second of the one or more third flow regulators. In some embodiments, the one or more third pumps is between a first of the one or more third flow regulators and the mixing section. For example, a first of the one or more third flow regulators may comprise a valve and a third pump may comprise a variable frequency drive pump.

In some embodiments, the third input comprises a third auxiliary output for coupling to the source of first additive. For example, the third auxiliary output comprises a tubular member for coupling to the source of first additive. The third auxiliary output allows the first additive from the source of first additive that has entered the third input to be provided back to the source of first additive. Such an arrangement reduces the need for additional tanks for storing the first additive that has entered the third input when it is not provided to the mixing section. The third auxiliary output may be positioned anywhere in the system that allows for it provide said purpose. For example, the third auxiliary output may be between one of the one or more third pumps and one of the one or more third flow regulators. For example, the third auxiliary output may between the third pump and the third flow regulator.

In some embodiments, the third input comprises a third pump between a first third flow regulator and a second third flow regulator. The first third flow regulator may be between an end of the third input for coupling to the source of first additive and the third pump. The second third flow regulator may be between the third pump and the mixing section. The third auxiliary output may be between the third pump and the second third flow regulator.

### Fourth Input Components

In some embodiments, the system comprises a fourth input for coupling to a source of second additive, and coupled to the mixing section. When the system comprises a fourth input coupled to the mixing section, the mixer is for mixing the water from the source of water with first additive from the source of first additive and second additive from the source of second additive to form an aqueous phase.

In some embodiments, the fourth input is a tubular member with an internal diameter of from about 0.01 m to about 0.5 m; optionally from about 0.01 m to about 0.2 m; preferably from about 0.01 m to about 0.15 m.

In some embodiments, the fourth input comprises one or more fourth flow regulators, preferably between the source of second additive and the mixing section. For example, the fourth input may comprise one or more fourth flow regulators between an end of the fourth input for coupling to the source of second additive and the mixing section. For example, the fourth input may comprise 1, 2, 3 or more fourth flow regulators. Preferably, the fourth input comprises 1 or 2 fourth flow regulators. For example, the fourth input comprises 1 fourth flow regulator. For example, a first of the one or more fourth flow regulators may comprise a valve and a second of the one or more fourth flow regulators may comprise a variable frequency drive pump.

In some embodiments, the fourth input comprises one or more fourth pumps, preferably between the source of second additive and the mixing section. For example, the fourth input may comprise one or more fourth pumps between an end of the fourth input for coupling to the source of second additive and the mixing section. For example, the fourth input may comprise 1, 2, 3 or more fourth pumps. Preferably, the fourth input comprises 1 or 2 fourth pumps. For example, the fourth input comprises 1 fourth pump.

In some embodiments, one of the one or more fourth pumps is between an end of the fourth input for coupling to the source of second additive and one of the one or more fourth flow regulators. For example, the fourth input comprises a fourth pump between an end of the fourth input for coupling to the source of second additive and a fourth flow regulator. The fourth flow regulator being between the fourth pump and the mixing section.

In some embodiments, the one or more fourth pumps is between a first of the one or more fourth flow regulators and a second of the one or more fourth flow regulators. In some embodiments, the one or more fourth pumps is between a first of the one or more fourth flow regulators and the mixing section. For example, a first of the one or more fourth flow regulators may comprise a valve and a fourth pump may comprise a variable frequency drive pump.

In some embodiments, the fourth input comprises a fourth auxiliary output for coupling to the source of second additive. For example, the fourth auxiliary output comprises a tubular member for coupling to the source of second additive. The fourth auxiliary output allows the second additive from the source of second additive that has entered the fourth input to be provided back to the source of second additive. Such an arrangement reduces the need for additional tanks for storing the second additive that has entered the fourth input when it is not provided to the mixing section. The fourth auxiliary output may be positioned anywhere in the system that allows for it provide said purpose. For example, the fourth auxiliary output may be between one of the one or more fourth pumps and one of the one or more fourth flow regulators. For example, the fourth auxiliary output may between the fourth pump and the fourth flow regulator.

In some embodiments, the fourth input comprises a fourth pump between a first fourth flow regulator and a second fourth flow regulator. The first fourth flow regulator may be between an end of the fourth input for coupling to the source of second additive and the fourth pump. The second fourth flow regulator may be between the fourth pump and the mixing section. The fourth auxiliary output may be between the fourth pump and the second fourth flow regulator.

### Fifth Input Components

In some embodiments, the system comprises a fifth input for coupling to a source of a third additive, and coupled to the mixing section. When the system comprises a fifth input coupled to the mixing section, the mixer is for mixing the water from the source of water with first additive from the source of first additive and third additive from the source of third additive (and optionally second additive from the source of second additive) to form an aqueous phase.

### Sixth Input Components

In some embodiments, the system comprises a sixth input for coupling to a source of a fourth additive, and coupled to the mixing section. When the system comprises a sixth input coupled to the mixing section, the mixer is for mixing the water from the source of water with first additive from the source of first additive and fourth additive from the source of fourth additive (and optionally second additive from the source of second additive and/or third additive from the source of third additive) to form an aqueous phase.

### Auxiliary Inputs

In some embodiments, the system comprises one or more auxiliary inputs for coupling to one or more of the first input, the second input, the third input, the intermediate section, the mixing section, the blender, the output, the intermediate output section, and/or the output modulation section.

### Other Components

### Heaters

In some embodiments, the system comprises one or more heaters. For example, each heater may individually be a steam heater, a condensing heater or an electrical heater.

The heaters may be comprised in any section of the system, depending on the system's needs. For example, heaters may be comprised in any of the first input, second input, third input, fourth input, fifth input, sixth input and/or any or all of the auxiliary inputs. In some embodiments, each of the mixing section, the intermediate section, the blender, the output, the intermediate output section, and/or the output modulation section individually may comprise a heater. In some embodiments, one or more of the first container, second container and/or container of the output modulation section comprises a heater. In preferred embodiments, each of the first container, second container and/or container of the output modulation section comprises a heater.

In some embodiments, one or more of the source of fuel, source of first additive, source of water, and/or source of second additive comprises one or more heaters. Preferably, each of the source of fuel, source of first additive, source of water, and source of second additive comprises one or more heaters.

When the system comprises one or more heaters, it is possible for the system to produce an oil-in-water emulsion more efficiently.

### Viscometers

In some embodiments, the system comprises one or more viscometers. The viscometers may be comprised in any section of the system, depending on the system's needs. Optionally, the system comprises a viscometer between the blender and the engine of a vehicle. For example, viscometers may be comprised in any of the first input, second input, third input, fourth input, fifth input, sixth input or any or all of the auxiliary inputs. In some embodiments, each of the mixing section, the intermediate section, the blender, the output, the intermediate output section, and/or the output modulation section individually may comprise a viscometer. In some embodiments, the output or the intermediate output section may comprise a viscometer. Optionally, the output modulation section comprises a viscometer. Preferably, the system comprises a viscometer between the blender and the first container and/or second container.

The skilled person can select a viscometer that is suitable for use in the section of the system in which it is comprised. In some embodiments, each viscometer may be individually selected from the Anton-Paar L-vis product range, Brookfield Fast product range, and/or the Emerson micro motion Coriolis flow meter product range.

### Particle Size Analysers

In some embodiments, the system comprises one or more particle size analysers. The particle size analysers may be comprised in any section of the system, depending on the system's needs. Optionally, the system comprises a particle size analyser between the blender and the engine of a vehicle. For example, particle size analysers may be comprised in any of the first input, second input, third input, fourth input, fifth input, sixth input or any or all of the auxiliary inputs. In some embodiments, each of the mixing section, the intermediate section, the blender, the output, the intermediate output section, and/or the output modulation section individually may comprise a particle size analyser. In some embodiments, the output or the intermediate output section may comprise a particle size analyser. Optionally, the output modulation section comprises a particle size analyser. Preferably, the system comprises a particle size analyser between the blender and the first container and/or second container.

The skilled person can select a particle size analyser that is suitable for use in the section of the system in which it is comprised. In some embodiments, each particle size analyser may be individually selected from the Malvern Insitec product range, Metter Toledo Particle Track product range, and/or a Jorin in-line particle analyzer.

### Controller

In some embodiments, the system comprises one or more controllers configured to receive an output from one or more of a flow regulator, blender, mixer, pump, heater, viscometer, and/or particle size analyser and output a controlling signal to one or more of a flow regulator, blender, mixer, pump, heater, viscometer, and/or particle size analyser. In preferred embodiments, a controller is configured to receive an output from a viscometer and output a controlling signal to one or more of the pumps, flow regulators, mixer, and/or blender. Systems comprising such controllers allow for real-time tuning of the oil-in-water emulsion. That is, when the system comprises a controller, it is possible to tune the properties of the oil-in-water emulsion to be particularly suitable for use in an engine. For example, the properties of the oil-in-water emulsion may be tuned so that they are particularly suitable for a specific engine or an operating condition of an engine.

In some embodiments, the controller is configured to receive an output from an emission sensor and output a controlling signal to one or more of a flow regulator, blender, mixer, pump, heater, viscometer, and/or particle size analyser. In preferred embodiments, the controller is configured to receive an output from an emission sensor and output a controlling signal to one or more of the pumps, flow regulators, mixer, and/or blender. In some embodiments, the emission sensor may be one or more selected from an oxygen sensor, carbon monoxide sensor, carbon monoxide sensor, NOx sensor, or sulphur sensor. Systems comprising such controllers allow for real-time tuning of the oil-in-water emulsion. That is, when the system comprises a controller, it is possible to tune the properties of the oil-in-water emulsion to allow the engine to exhaust a gas with a specific emission profile.

In some embodiments, the controller is configured to receive an output from an engine sensor (for example an engine cylinder pressure sensor) and output a controlling signal to one or more of a flow regulator, blender, mixer, pump, heater, viscometer, and/or particle size analyser. In preferred embodiments, the controller is configured to receive an output from an engine sensor and output a controlling signal to one or more of the pumps, flow regulators, mixer, and/or blender. Systems comprising such controllers allow for real-time tuning of the oil-in-water emulsion. That is, when the system comprises a controller, it is possible to tune the properties of the oil-in-water emulsion so the specific operating load of the engine.

### Sources of Inputs

The source of fuel on a vehicle may be any source of fuel on a vehicle. The purpose of the source of fuel on vehicle is to store a volume of fuel. For example, the source of fuel on a vehicle may be a container such as a tank. In some embodiments, the source of fuel on a vehicle is two or more containers, for example 2 or 3 or 4 containers. Each container may have a volume of between about 1×10⁴ litres and about 1×10⁷ litres. In such systems, the first input for coupling to a source of fuel on a vehicle may be for coupling to any or each of the containers. In preferred embodiments, the source of fuel on a vehicle is a single container. In some embodiments, the source of fuel on a vehicle comprises a valve. Preferably, the source of fuel on a vehicle comprises a valve between an output of the source of fuel on a vehicle and the first input.

The source of water may be any source of water. The purpose of the source of water is to store a volume of water. For example, the source of water may be a container such as a tank. In some embodiments, the source of water is two or more containers, for example 2 or 3 or 4 containers. Each container may individually have a volume of between about 1×10³ litres and about 1×10⁷ litres. In such systems, the second input for coupling to a source of water may be for coupling to any or each of the containers. In preferred embodiments, the source of water is a single container. In some embodiments, the source of water comprises a valve. Preferably, the source of water comprises a valve between an output of the source of water and the second input.

The source of first additive may be any source of first additive. The purpose of the source of first additive is to store a volume of first additive. For example, the source of first additive may be a first additive container such as a tank. In some embodiments, the source of first additive is a single first additive container. In some embodiments, the source of first additive is two or more first additive containers, for example 2, 2 or 3 or 4 or 5 first additive containers. In such systems, the second input for coupling to a source of first additive may be for coupling to any or each of the two or more first additive containers. In some embodiments, the source of first additive comprises a valve. Preferably, the source of first additive comprises a valve between an output of the source of first additive and the third input. For example, one or more of the two or more first additive containers comprises a valve between an output of the respective first additive container and the third input. For example, each of the two or more first additive containers comprises a valve between an output of the respective first additive container and the third input.

Each first additive container may individually have a volume of greater than about 200 litres, optionally greater than about 500 litres, about 1000 litres or about 2000 litres. Each first additive container may individually have a volume of between about 200 litres and about 5000 litres; between about 200 litres and about 2000 litres; between about 200 litres and about 1000 litres. Each first additive container may individually have a volume of between about 200 litres and about 5000 litres; between about 500 litres and about 5000 litres; between about 1000 litres and about 5000 litres; or between about 2000 litres and about 5000 litres.

In some embodiments, when the source of first additive is two or more first additive containers, each of the two or more first additive containers may be for storing a volume of a first additive. For example, each of the two or more first additive containers may be for storing a volume of different first additive. That is, the first additive may be one or more first additives. In such embodiments, the system allows for the different first additives to be stored separately. For example, each of the different first additives may be stored in a different first additive container. As such, problems associated with pre-mixing the additives can be avoided.

When the source of first additive is two or more first additive containers, the second input may be for coupling to each of the two or more first additive containers. In such embodiments, the second input may be for coupling directly to each of the two or more first additive containers. That is, the second input may be in fluid connection with each of the two or more first additive containers.

When the source of first additive is two or more first additive containers, the second input may be for coupling to each of the two or more containers via two or more container linking sections. That is, the second input is coupled to each of the two or more respective container linking sections and the respective container linking sections are for coupling to the two or more respective first additive containers.

For example, the second input may be coupled to a first first additive container linking section which is for coupling to a first first additive container; the second input may be coupled to a second first additive container linking section which is for coupling to a second first additive container; the second input may be coupled to a third first additive container linking section which is for coupling to a third first additive container; the second input may be coupled to a fourth first additive container linking section which is for coupling to a fourth first additive container; and/or the second input may be coupled to a fifth first additive container linking section which is for coupling to a fifth first additive container.

Each of the first first additive container linking section; second first additive container linking section; third first additive container linking section; fourth first additive container linking section; and/or fifth first additive container linking section may individually be coupled to the respective first additive container and the second input.

The purpose of each of the first first additive container linking section; second first additive container linking section; third first additive container linking section; fourth first additive container linking section; and/or fifth first additive container linking section is to provide a fluid connection between the respective first additive container and the second input.

Each of the first first additive container linking section; second first additive container linking section; third first additive container linking section; fourth first additive container linking section; and/or fifth first additive container linking section may individually comprise one or more flow regulators. Each of the first first additive container linking section; second first additive container linking section; third first additive container linking section; fourth first additive container linking section; and/or fifth first additive container linking section may individually comprise one or more pumps.

Each of the first first additive container linking section; second first additive container linking section; third first additive container linking section; fourth first additive container linking section; and/or fifth first additive container linking section may be a tubular or non-tubular section, for example a pipe or a container.

Each of the first first additive container linking section; second first additive container linking section; third first additive container linking section; fourth first additive container linking section; and/or fifth first additive container linking section may comprise an auxiliary output section for coupling to the respective first additive container. Each of the auxiliary outputs allows the respective first additive from the respective first additive container that has entered the respective first additive container linking section to be provided back to the respective first additive container.

The source of second additive may be any source of second additive. The purpose of the source of second additive is to store a volume of second additive. For example, the source of second additive may be a second additive container such as a tank. In some embodiments, the source of second additive is a single second additive container. In some embodiments, the source of second additive is two or more second additive containers, for example 2 or 3 or 4 or 5 second additive containers. In such systems, the fourth input for coupling to a source of second additive may be for coupling to any or each of the two or more second additive containers. In some embodiments, the source of second additive comprises a valve. Preferably, the source of second additive comprises a valve between an output of the source of second additive and the fourth input. For example, one or more of the two or more second additive containers comprises a valve between an output of the respective second additive container and the fourth input. For example, each of the two or more first additive containers comprises a valve between an output of the respective second additive container and the fourth input.

Each second additive container may individually have a volume of greater than about 1000 litres, optionally greater than about 10000 litres, about 100000 litres or about 1000000 litres. Each second additive container may individually have a volume of between about 1000 litres and about 10000 litres; between about 1000 litres and about 100000 litres; between about 1000 litres and about 1000000 litres; or between about 1000 litres and about 10000000 litres. Each second additive container may individually have a volume of between about 1000 litres and about 50000 litres; between about 5000 litres and about 500000 litres; between about 1000 litres and about 50000 litres; or between about 2000 litres and about 50000 litres.

### Fuel

The fuel of the source of fuel on a vehicle may be any fuel used to power an engine. For example, the fuel may be suitable for powering a main engine or one or more auxiliary engines.

The fuel may comprise one or more hydrocarbons. In some embodiments, the fuel comprises a marine fuel, biofuel, bio-oil, residual fuel oil, and/or distillate fuel oil. For example, the fuel may be a lignin bio oil or pyrolysis oil. In some embodiments, the fuel consists of a marine fuel, biofuel, bio-oil, residual fuel oil, and/or distillate fuel oil. For example, the fuel may consist of a lignin bio oil or pyrolysis oil.

The fuel may have a dynamic viscosity of less than about 1000 cP at 50° C. and 100 s⁻¹; optionally less than about 700 cP at 50° C. and 100 s⁻¹; optionally less than about 500 cP at 50° C. and 100 s⁻¹.

In some embodiments, the fuel may have a dynamic viscosity of less than about 1000 cP at 150° C. and 100 s⁻¹; less than about 500 cP at 150° C. and 100 s⁻¹; optionally less than about 400 cP at 150° C. and 100 s⁻¹; optionally less than about 300 cP at 150° C. and 100 s⁻¹.

In some embodiments, the fuel may have a dynamic viscosity of up to 300 000 cP at 100° C. and 100 s⁻¹. For example, 1 cP or more at 25° C. and 100 s⁻¹, or 10 cP or more at 100° C. and 100 s⁻¹. For example, 180 cP or more at 25° C. and 100 s⁻¹, and preferably 250 cP or more at 25° C. and 100 s⁻¹.

Dynamic viscosity is measured using standard techniques, and equipment such as the Malvern Kinexus™, which measures viscosity at controlled temperature and shear rates.

### Water

The water from the source of water may come from a variety of sources. For example, the water may be water from a potable water source on a vehicle. For example, the water may be derived from a reverse osmosis unit. For example, the water may be de-ionised water. An example of a water specification that can be used is given in Table 2.

TABLE 2
Example of water specification for
oil-in-water emulsion production

| Parameter | Value |
|---|---|
| Suspended solids | Less than 10 mg/l and Filtered to 35 μm |
| Chlorides, mg/l | Less than 50 |
| Alkali metals, mg/l | Less than 20 |
| Alkaline earth metals, mg/l | Less than 30 |
| Silicon as SiO₂, mg/l | Less than 40 |
| pH | 6.5 to 8 |
| Total hardness | Max 6° dH |

Optionally, the water can be pretreated, for example by filtration and/or deionization. In some embodiments, the water content of the oil-in-water emulsions of the present invention may be from trace amounts to 40 wt %, typically in the range of from 5 to 30 wt %. Preferably the water content is in the range of from 5 to 15 wt %.

### Additives

The first additive may be one or more first additives. Each of the first additives may individually be selected from the group consisting of surfactants, polymeric stabilisers, flow improving agents, acids, alcohols and mixtures thereof. Each of the second additive, third additive, and fourth additive may individually be selected from the group consisting of surfactants, polymeric stabilisers, flow improving agents, acids, alcohols and mixtures thereof.

### Surfactants

The surfactant may be present in an amount ranging from 0.05 to 0.6% wt of the oil-in-water emulsion. The aim of the surfactant is to act as an emulsifier, to stabilise the oil phase droplets in the aqueous phase. A range of from 0.05 to 0.5 wt % surfactant may be used, for example 0.08 to 0.4 wt %.

A number of surfactants can be employed. There can be one surfactant or a combination of more than one surfactant. At least one surfactant, optionally all the surfactants, may be selected from one or more of the following:
fatty alkyl amines according to the formula;

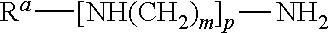

where;
R^{a} is an aliphatic group having 12 to 24 carbon atoms (preferably 12-14, 14-16, 16-18, 18-20, 20-22 or 22-24 carbon atoms)
m is a number 2 or 3
p is a number 0 to 3;
ethoxylated fatty alkyl amines according to the formula;

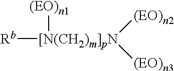

where;
R^{b} is an aliphatic group having from 12 to 24 carbon atoms (preferably 12-14, 14-16, 16-18, 18-20, 20-22 or 22-24 carbon atoms)
m is a number 2 or 3
p is a number 1 to 3
n1, n2 and n3 are each independently a number within the range greater than 0 to 70, for example from 2 to 70, or from 3 to 70. In one embodiment, n1+n2+n3 is a number greater than 0 and up to 210. Each of n1, n2 and n3 may or may not be an integer;
ethoxylated fatty alkyl monoamines according to the formula;

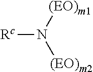

where;
R^{c} is an aliphatic group having from 12 to 24 carbon atoms (preferably 12-14, 14-16, 16-18, 18-20, 20-22 or 22-24 carbon atoms)
m1 and m2 are each a number within the range greater than 0 and up to 70, for example from 2 to 70, or from 3 to 70. In one embodiment, m1+m2 is a number greater than 0 and up to 140. Each of m1 and m2 may or may not be an integer;
methylated fatty alkyl monoamines according to the formula;

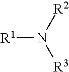

where;
one or two of the groups R¹, R², and R³ are each independently selected from aliphatic groups having from 8 to 22 carbon atoms (preferably 8-10, 10-12, 12-14, 14-16, 16-18, 18-20 or 20-22 carbon atoms)
the remaining groups of R¹, R², and R³ are methyl;
methylated fatty alkyl amines according to the formula;

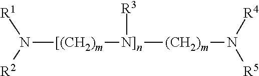

where;
one or two of the groups R¹ to R⁵ are independently selected from aliphatic groups having from 8 to 22 carbon atoms (preferably 8-10, 10-12, 12-14, 14-16, 16-18, 18-20 or 20-22 carbon atoms)
the remaining groups of R¹ to R⁵ are methyl
n is an integer from 1 to 5
m is 2 or 3;
or according to the formula;

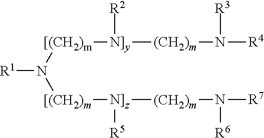

where;
one or two of the groups R¹ to R⁷ are each selected from aliphatic groups having from 8 to 22 carbon atoms (preferably 8-10, 10-12, 12-14, 14-16, 16-18, 18-20 or 20-22 carbon atoms)
the remaining groups of R¹ to R⁷ are methyl
m is 2 or 3
y and z are integers from 0 to 4, and (y+z) is 0 to 4;
or according to the formula;

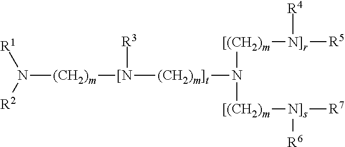

where;
one or two of the groups R¹ to R⁷ are an aliphatic group containing 8 to 22 carbon atoms (preferably 8-10, 10-12, 12-14, 14-16, 16-18, 18-20 or 20-22 carbon atoms) the remaining groups of R¹ to R⁷ are methyl
m is 2 or 3
t is between 0 to 3
r and s are between 1 to 4, and (t+r+s) is between 2 to 5;
and;
quaternary fatty alkyl amines according to the formula;

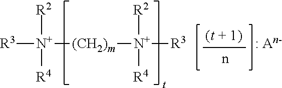

where;
R¹ is an aliphatic group having 12 to 24 carbon atoms (preferably 12-14, 14-16, 16-18, 18-20, 20-22, or 22-24 carbon atoms), e.g. —(CH₂)_{y}—CH₃, optionally comprising a carbonyl group adjacent to the nitrogen atom, i.e. —C(O)—(CH₂)_{(y-1)}—CH₃, where y is from 10 to 22 (preferably y is 10-12, 12-14, 14-16, 16-18, 18-20 or 20-22);
R² and R³ are independently at each occurrence selected from H or an aliphatic group having from 1 to 6 carbon atoms, preferably from 1 to 3 carbon atoms, and more preferably 1 carbon atom;
R⁴ is selected from H or a C₁₋₄ aliphatic group;
m is 2 or 3;
t is from 0 to 4
A is an anion;
n is the valence of the anion.

The aliphatic groups mentioned in the formulae above, including those containing a carbonyl group, can optionally be substituted, typically with one or more, for example from 1 to 3, substituents which are independently selected from hydroxyl, C₁₋₃ alkyl, C₁₋₃ alkoxy, or C₁₋₃ hydroxyalkyl. Preferably, there are no substituents on the aliphatic groups. Each aliphatic group can be saturated, or can comprise double or triple carbon-carbon bonds, for example up to 6 double bonds, for example up to 3 double bonds.

Preferably, R¹ has a formula C₁₄₋₂₀H₂₄₋₄₁, or C(O)C₁₃₋₁₉H₂₂₋₃₉. More preferably it has a formula C₁₄₋₂₀H₂₄₋₄₁.

Preferably, each R² and R³ is independently selected from CH₃, H and CH₂CH₂OH.

Preferably, each R⁴ is independently selected from CH₃ and H.

Examples of fatty alkyl amines include:
quaternary fatty alkyl monoamines according to the formula;

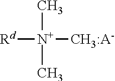

where;
R^{d} is an aliphatic group having 12 to 24 carbon atoms (preferably 12-14, 14-16, 16-18, 18-20, 20-22, or 22-24 carbon atoms)
A is an anion;
and
quaternary fatty alkyl diamines according to the formula;

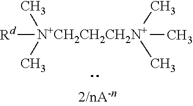

where;
R^{d} is an aliphatic group having 12 to 24 carbon atoms (preferably 12-14, 14-16, 16-18, 18-20, 20-22, or 22-24 carbon atoms)
A is an anion
n is the valence of the anion.

In the above, the anion A is preferably selected from those anions which bind more strongly to the quaternary amine than carbonate. Examples include halide, particularly Cl⁻, and organic anions such as formate (HCOO⁻), acetate (CH₃COO⁻) and methane sulfonate (CH₃SO₃⁻).

In the above, the group “EO” is an ethoxylate group (—CH₂CH₂O—). The ethoxylate group (or polyether group for more than one linked ethoxylate group) is typically terminated by H, i.e. —CH₂CH₂OH.

In embodiments, the surfactant is selected from one or more fatty alkyl di-, tri- and tetra-amines, ethoxylated fatty alkyl mono-, di- and tri-amines, and quaternary fatty alkyl amines.

In further embodiments, the surfactant is selected from one or more fatty alkyl diamines, fatty alkyl tetra-amines, ethoxylated fatty alkyl diamines, and quaternary fatty alkyl amines. Examples include fatty alkyl tripropylenetetramine, such as tallow tripropylenetetramine, fatty alkyl propylene diamines, oleyldiamine ethoxylate.

The term “fatty alkyl” includes not only saturated groups (i.e. C₁₂ to C₂₄ alkyl groups, preferably C₁₂₋₁₄, C₁₄₋₁₆, C₁₆₋₁₈, C₁₈₋₂₀, C₂₀₋₂₂ Or C₂₂₋₂₄), but also partially unsaturated C₁₂ to C₂₄ groups (i.e. C₁₂ to C₂₄ alkenyl groups, preferably C₁₂₋₁₄, C₁₄₋₁₆, C₁₆₋₁₈, C₁₈₋₂₀, C₂₀₋₂₂ or C₂₂₋₂₄), for example having up to six C═C double bonds. Preferred fatty alkyl groups have no more than 3 double bonds. Examples of fatty alkyl groups include oleyl (C18, 1 double bond), and other groups associated with tallow, e.g. palmityl (C16, 0 double bonds), stearyl (C18, no double bonds), myristyl (C14, no double bonds), palmitoleyl (C16, 1 double bond), linoleyl (C18, 2 double bonds) and linolenyl (C18, 3 double bonds). The term “fatty alkyl” includes both natural and synthetic alkyl groups, for example synthetic alkyl groups may comprise C₁₅ or C₁₇. Examples of suitable fatty alkyl groups include C₁₂, C₁₃, C₁₄, C₁₅, C₁₆, C₁₇ and C₁₈ groups, each of which may be fully saturated or may comprise one or more double bonds.

The surfactant may be selected based on the composition of the aqueous phase, the oil phase and/or the oil-in-water emulsion as a whole. For example, the surfactant may be selected to ensure that the components of the aqueous phase or oil phase are soluble with each other. For example, the surfactant may be selected to ensure that the components of the phase containing a C₁ to C₁₀ mono or di hydric alcohol are soluble with each other.

### Alcohol

In some embodiments, the alcohol is selected from the list consisting of C₁ to C₁₀ mono or di hydric alcohols. In some embodiments, the alcohol may be glycerol.

In some embodiments, the oil-in-water emulsion comprises from 10 to 60 wt % glycerol, wherein the sum of components in the emulsion does not exceed 100 wt %. For example, the oil-in-water emulsion may comprise about 40, about 50 or about 60 wt % glycerol, wherein the sum of components in the emulsion does not exceed 100 wt %.

The oil-in-water emulsion may comprise from about 0.5 to about 70 wt % of an alcohol selected from the list consisting of C₁ to C₁₀ mono or di hydric alcohols, wherein the sum of components in the emulsion does not exceed 100 wt %. For example, the oil-in-water emulsion may comprise from about 1 to about 60 wt %, from about 1 to about 50 wt %, from about 1 to about 40 wt %, from about 1 to about 30 wt %, or from about 1 to about 25 wt % of an alcohol selected from the list consisting of C₁ to C₁₀ mono or di hydric alcohols, wherein the sum of components in the emulsion does not exceed 100 wt %. In some embodiments, the oil-in-water emulsion may comprise from about 2 to about 25 wt % of an alcohol selected from the list consisting of C₁ to C₁₀ mono or di hydric alcohols, wherein the sum of components in the emulsion does not exceed 100 wt %.

For example, the oil-in-water emulsion may comprise about 2, about 10, about 15, about 20, or about 25 wt. % of an alcohol selected from the list consisting of C₁ to C₁₀ mono or di hydric alcohols, wherein the sum of components in the emulsion does not exceed 100 wt %.

In some embodiments, the C₁ to C₁₀ mono or di hydric alcohol is a linear or branched C₁ to C₁₀ mono or di hydric alcohol. In some embodiments, the alcohol is selected from the list consisting of C₁ to C₆ mono or di hydric alcohols. In some embodiments, the C₁ to C₁₀ mono or di hydric alcohol is a linear or branched C₁ to C₆ mono or di hydric alcohol. In some embodiments, the alcohol is selected from the list consisting of C₁ to C₄ mono or di hydric alcohols. In some embodiments, the C₁ to C₄ mono or di hydric alcohol is a linear or branched C₁ to C₄ mono or di hydric alcohol.

In some embodiments, the alcohol is selected from the list consisting of C₁ to C₁₀ mono hydric alcohols, C₁ to C₆ mono hydric alcohols, or C₁ to C₄ mono hydric alcohols. The C₁ to C₄ mono hydric alcohol may be methanol, ethanol, propanol, or butanol. For example, the di hydric alcohol may be ethylene glycol. For example, the alcohol may be selected from methanol, ethanol, or butanol (for example 1-butanol, iso-butanol, sec-butanol, or tert-butanol).

In some embodiments, the C₁ to C₁₀ mono or di hydric alcohol may refer to two or more (for example two, three or four) alcohols each individually selected from the list consisting of C₁ to C₁₀ mono or di hydric alcohols.

In some embodiments, the oil-in-water emulsion described herein may comprise from about 0.5 to about 70 wt % of a second alcohol individually selected from the list consisting of C₁ to C₁₀ mono or di hydric alcohols provided that the sum of C₁ to C₁₀ mono or di hydric alcohols in the oil-in-water emulsion is from about 1 to about 70 wt % and the sum of components in the emulsion does not exceed 100 wt %. For example, the oil-in-water emulsion may comprise a first alcohol (for example methanol) and a second alcohol (for example ethanol) provided that the sum of the C₁ to C₁₀ mono or di hydric alcohols in the oil-in-water emulsion is from about 1 to about 70 wt % and the sum of components in the emulsion does not exceed 100 wt %.

In some embodiments, the ratio of glycerol:alcohol in the glycerol containing phase is from about 20:1 to about 1:5, for example, from about 38:2 to about 1.5:2.5. In some embodiments, the ratio of glycerol:alcohol in the glycerol containing phase is about 38:2, about 3:10; about 2.5:1.5; about 2:2, or about 1.5:2.5.

In some embodiments, glycerol containing phase has a density of between 0.8 g/mL and about 1.3 g/mL (measured at 25° C. and using the method described in ISO 15212-1).

### Polymeric Stabiliser

In some embodiments, one or more polymeric stabilisers are included in amounts of up to 0.25 wt % of the oil-in-water emulsion. In embodiments, they are present in amounts in the range of from 0.01 to 0.10 wt %.

Polymeric stabilising and flow improvement agents may be used to improve static stability in storage by compensating for the density differential between the residue and aqueous phase. They can also modify the viscosity characteristics of the emulsion.

The polymer stabilising additive can form a weakly ‘gelled’ structure in the aqueous additive-containing phase, which helps to improve static stability of the oil-in-water emulsion by holding the hydrocarbon residue droplets apart, preventing sedimentation during static storage conditions. The weak gel structure can also impart low resistance or yield to applied stress to ensure suitable low viscosity characteristics of the emulsion, for example during pumping and handling. This behaviour can also be recoverable, for example once the oil-in-water emulsion fuel is pumped into a tank it can recover its static stability characteristics. The polymer additive can help to achieve this by interacting with the other additives in the formulation through entanglement and bonding mechanisms, forming a molecularly structured gel.

There can be one or more than one polymeric stabiliser and flow improving agent. At least one polymeric stabiliser and flow improving agent is selected from polymers containing monomers comprising dialkylaminoalkyl acrylate or dialkylaminoalkyl methacrylate quaternary salts, or dialkylaminoalkylacrylamides or methacrylamides and their quaternary salts.

Examples of such polymeric stabilisers and flow improving agents include cationic polymers comprising at least one cationic monomer selected from the group of dialkylaminoalkyl acrylate or dialkylaminoalkyl methacrylate quaternary salts such as dimethylaminoethyl acrylate methyl chloride quaternary salt, dimethylaminoethyl acrylate methyl sulfate quaternary salt, dimethylaminoethyl acrylate benzyl chloride quaternary salt, dimethylaminoethyl acrylate sulfuric acid salt, dimethylaminoethyl acrylate hydrochloric acid salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, or dialkylaminoalkylacrylamides or methacrylamides and their quaternary salts such as acrylamidopropyltrimethylammonium chloride, dimethylaminopropyl acrylamide methyl sulfate quaternary salt, dimethylaminopropyl acrylamide methyl saulfate quaternary salt, dimethylaminopropyl acrylamide sulfuric acid salt, dimethylaminopropyl acrylamide hydrochloride salt, methacrylamidopropyltrimethylammonium chloride, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate, diallyldimethylammonium chloride, and diallyldimethylammonium chloride.

Additional polymeric stabilisers and flow improving agents may be selected from one or more alkyl hydroxyalkyl cellulose ethers (water soluble), preferably having an alkyl group with 1 to 3 carbon atoms, and an hydroxyalkyl group (e.g., hydroxyethyl or hydroxypropyl), where;
DS_{alkyl} is in the range of from 0.1 to 2.5;
MS_{hydroxyalkyl} is in the range of from 0.2 to 4.0;
weight average molecular weight is in the range of from 100,000 to 2,000,000 Da (ideally from 800,000 to 1,600,000 Da);
Examples include methyl ethyl hydroxyethyl cellulose ether (water soluble), preferably having
DS_{methyl} in the range of from 0.3 to 1.5
DS_{ethyl} in the range of from 0.1 to 0.7
MS_{hydroxyethyl} in the range of from 0.2 to 3.0.

DS represents the degree of substitution of the specified component, and MS represents the extent of molar substitution of the specified component.

Further examples of additional polymeric stabilisers include those where (in the formula represented below) R is H, CH₃ and/or [CH₂CH₂O]ₙH.

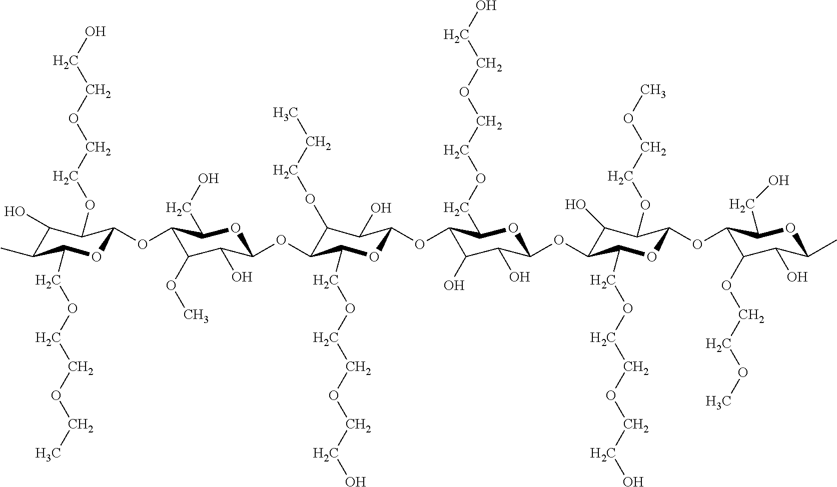

Other examples of additional polymeric stabiliser and flow improvement agent can include guar gum, starch and starch derivatives, hydroxy ethyl cellulose, and ethyl hydroxy ethyl cellulose.

### Acid

An acid, i.e. a Brønsted acid, may be used to activate the surfactant. In some embodiments, the oil-in-water emulsions and/or the aqueous phase have a pH of 2 to 6, and more preferably in the range 2 to 4.5, or 3 to 4.5.

The acid may be selected from one or more organic acids. Organic acids comprise at least one C—H bond, examples of which include methanesulfonic acid, formic acid, acetic acid, citric acid, para-toluene sulfonic acid, and benzoic acid. At least one of the organic acids (optionally all) is preferably selected from methanesulfonic acid, formic acid, acetic acid, citric acid, benzoic acid, and para-toluene sulfonic acid. Preferably, at least one (optionally all) of the acids are selected from formic acid and methanesulfonic acid.

### Other Aspects

In a third aspect, the present invention relates to a vehicle comprising a system as described herein. In some embodiments, the vehicle comprises one or more of the source of fuel, the source of water, the source of first additive, the source of second additive, the source of third additive, and/or the source of fourth additive. Preferably, the vehicle comprises the source of fuel, the source of water, and the source of first additive.

In some embodiments, the vehicle comprises the source of fuel, the source of water, and the source of first additive; and the first input is coupled to the source of fuel; the second input is coupled to the source of water; and the third input is coupled to the source of first additive.

The vehicle may be any vehicle but preferably is a vessel such as a marine vessel.

In a fourth aspect, the present invention relates to the use of a system described herein. For example, to produce an oil-in-water emulsion on a vehicle, optionally wherein the vehicle is a vessel.

In a fifth aspect, the present invention relates to a process of forming an oil-in-water emulsion using a system as described herein.

In some embodiments, the process includes the steps of:
Providing a first additive;
Providing water;
Providing a fuel;
Mixing the first additive and the water in the mixing section to form an aqueous phase; and
Blending the aqueous phase with the fuel to form the oil-in-water emulsion.

### Definitions

As used herein, the term “A is coupled to B” means that A is in fluid connection with B.

As used herein, the term “A is for coupling to B” means that A is suitable for coupling to B. That is, A has features that make it suitable to be coupled to B.

As used herein, the term “A is between B and C” means that A is between B and C and is in fluid connection with B and C.

The term “in fluid connection with” means that there is a path that a fluid can flow between specific components. The skilled person understands how each component described herein can be made in fluid connection with every other component described herein.

As used herein, the term “distance” is intended to refer to the distance that a fluid in the system must travel.

The term tubular member include pipes, conduits, tubing, hoses or any other member that provides the function of allowing a fluid to move within its core. The cross section of the tubular member may be circular, substantially circular, square, rectangular, or any other cross section able to provide the required function.

The term end is intended to mean any part of a specific component. It is not intended to mean exclusively a further point/outer portion of a component. In this regard, a tubular member may have a plurality of ends. For example, a tubular member may have first end opposite a second end. In such a case, the two ends may be joined by substantially straight tubular section. Alternatively, a tubular member may have a first end next to a second end. In such a case, the two ends may be joined by tubular section with a bend angle of approximately 180°.

The inputs and components described herein have a length. The length of the input may be defined by the vehicle in which the system is installed. For example, in a marine vessel having inputs with a shorter length allows an operator to install the system in a room (for example an engine room) of a marine vessel. This avoids the need for extensive modification of the vessel to accommodate the system.

A marine vessel is any vessel that can operate in a marine environment, a fresh water environment or a mixture thereof. For example, a marine vessel may be a yacht, boat or ship.

As used herein, an engine of a vehicle may be an engine of a vessel such as a marine vessel. Reference to an engine herein includes a single engine or two or more engines. Each engine may individually be a main engine or an auxiliary engine. A main engine may be an engine that provides the force required to propel the vehicle through space (for example by powering a drive propeller and/or directional thrusters). An auxiliary engine may be an engine that does not provide the force required propel the vehicle through space. For example, an auxiliary engine may be for powering auxiliary systems on a vehicle (such as fluid systems, electronic systems, and/or any systems/components that do not directly propel the vehicle).

As used herein, a flow regulator may be any component that performs the function of regulating a flow of fluid in the system. For example, a flow regulator allows a flow of fluid to be increased or decreased. In some embodiments, each flow regulator described herein may individually be selected from a valve, a back pressure valve control loop, or a pump (for example variable frequency drive pump). A flow regulator may be a combination of one or more components. For example, a flow regulator may comprise a valve and a flow meter.

### Examples

The invention will be further described in relation to the non-limiting embodiments described below.

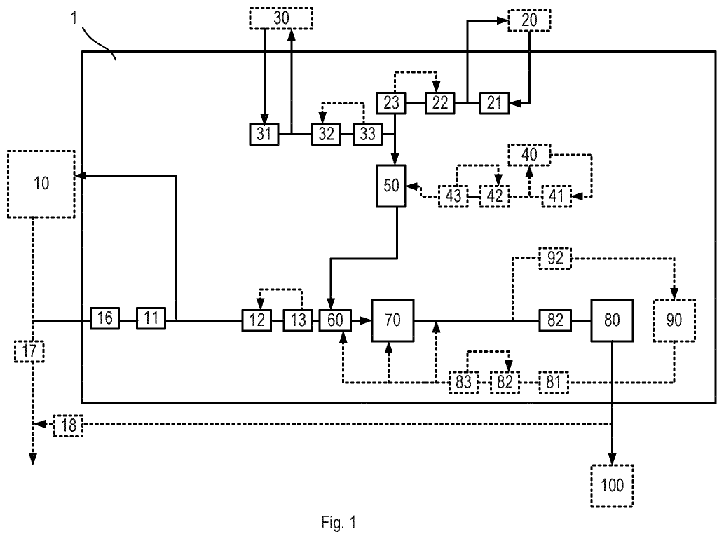

In some embodiments, the invention relates to a system for producing an oil-in-water emulsion as shown in FIG. 1; the system comprising: a first input for coupling to a source of fuel on a vehicle (10); a second input for coupling to a source of water (20); a third input for coupling to a source of first additive (30); a mixing section (50) for mixing the water and the first additive to form an aqueous phase; and a blender (70) for blending the aqueous phase with the fuel to form the oil-in-water emulsion; wherein the first input is coupled to the blender (70); the second input and the third input are coupled to the mixing section (50); and the mixing section (50) is coupled to the blender (70).

The first input comprises a first pump (11) between a first first flow regulator (16) and a second first flow regulator. In this embodiment, the second first flow regulator is a valve (12) and a flow meter (13).

The second input comprises a second pump (21) between an end of the second input for coupling to the source of water (20) and a second flow regulator. In this embodiment, the second flow regulator is a valve (22) and a flow meter (23).

The third input comprises a third pump (31) between an end of the third input for coupling to the source of first additive (30) and a third flow regulator. In this embodiment, the third flow regulator is a valve (32) and a flow meter (33).

The system may comprise a fourth input for coupling to a source of second additive (40). The fourth input may comprise a fourth pump (41) between an end of the fourth input for coupling to the source of second additive (40) and a fourth flow regulator. In this embodiment, the fourth flow regulator is a valve (42) and a flow meter (43).

The system comprises an intermediate section (60) and the mixing section (50) is coupled to the intermediate section (60) and the intermediate section (60) is coupled to the blender (70).

The system may comprise an intermediate output section for coupling to the engine of a vehicle and the output is coupled to the intermediate output section. The intermediate output section comprises a first container (80). The intermediate output section may comprise a second container (90). The intermediate output section may comprise one or more flow directors (82, 92) that are configured to allow a flow of fluid from the blender (70) to be provided to the first container (80) and/or the second container (90). The first container (80) comprises a first container output for coupling to the engine of a vehicle (100).

The first container output is coupled to one or more of the intermediate section (60), the blender (70), and/or the output. The second container comprises a second container output that is coupled to one or more of the intermediate section (60), the blender (70), and/or the output.

The intermediate output section comprises an intermediate output section pump (81) and an intermediate output section flow regulator between the first container output and the second container output, and one or more of the intermediate section (60), the blender (70), and/or the output. In this embodiment, the intermediate output section flow regulator is a valve (82) and a flow meter (83).

In FIG. 1, there is also shown flow regulators (17, 18) and the engine (100).

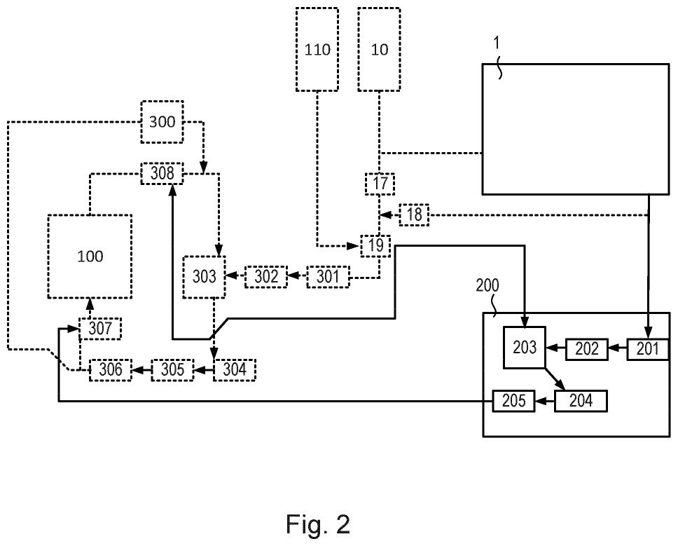

FIG. 2 shows an embodiment in which the system comprises the system (1) shown in FIG. 1 as well as an output modulation section (200).

The input of the output modulation section (200) is coupled to the output of the first container/additional first container output and the flow regulator (202); the flow regulator (202) is coupled to the input and the container (203); the container (203) is coupled to the flow regulator (202) and the pump (204); the pump (204) is coupled to the container (203) and the heater (205); the heater (205) is coupled to the container (203) and the output; and the output is coupled to the heater (205) and is for coupling to an engine of a vehicle (100). Additionally, the output modulation section comprises a pump (201) between the input and the flow regulator (202).

FIG. 2 also shows a secondary fuel source (110); flow regulators (17, 18, 19); pump (301); flow meter (302); container (303); pump (304); heater (305); viscometer (306); valve (307); engine (100); second engine (300); and valve (308).

In operation, the system of the invention allows for an operator to provide an engine of a vehicle with an oil-in-water emulsion at the appropriate time. For example, the engine (100) of a vehicle may be operating on fuel stored in the source of fuel (10) and/or the secondary fuel source (110). Fuel from the source of fuel (10) may be provided to the system (1). The fuel is blended with the aqueous phase to produce an oil-in-water emulsion. The resulting oil-in-water emulsion may be provided to the engine (100) via flow regulator (18) and/or via the output modulation section (200). If the system comprises the output modulation section (200), it may be coupled to a single engine, thereby allowing the operator to provide the oil-in-water emulsion to a single engine (for example on a vehicle with multiple engines). The operator may additionally/alternatively provide the oil-in-water emulsion to every engine in a vehicle (or part of a vehicle), by providing the oil-in-water emulsion to the vehicle main fuel line (via flow regulator (18)).

The operator can use a controller to determine the ratio of the components (i.e. the water, fuel, and additives) in the oil-in-water emulsion to suit an engine, a specific operation mode of an engine, or the output of an engine (for example, the emission profile of an exhaust fluid of an engine). The flow regulators allow the operator to provide the engine with a specific amount of oil-in-water emulsion. For example, the operator may operate an engine on a mixture of the oil-in-water emulsion and a fuel from the source of fuel or secondary fuel source.

### Modifications

It will be appreciated that many modifications may be made to the embodiments hereinbefore described. Such modifications may involve equivalent and other features which are already known to the skilled person and which may be used instead of or in addition to features already described herein. Features of one embodiment may be replaced or supplemented by features of another embodiment.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention. The applicant hereby gives notice that new claims may be formulated to such features and/or combinations of such features during the prosecution of the present application or of any further application derived therefrom.

1. A system for producing an oil-in-water emulsion; the system comprising
a first input for coupling to a source of fuel on a vehicle;
a second input for coupling to a source of water;
a third input for coupling to a source of first additive;
a mixing section for mixing the water and the first additive to form an aqueous phase; and
a blender for blending the aqueous phase with the fuel to form the oil in water emulsion; wherein
the first input is coupled to the blender;
the second input and the third input are coupled to the mixing section; and the mixing section is coupled to the blender.

2. (canceled)

3. A system according to claim 1, wherein the fuel comprises a marine fuel, biofuel, bio-oil, residual fuel oil, and/or distillate fuel oil.

4. A system according to claim 1, wherein the first additive is one or more first additives.

5. A system according to claim 1, wherein the first input comprises a first auxiliary output for coupling to the source of fuel on the vehicle; wherein the second input comprises a second auxiliary output for coupling to the source of water; and/or wherein the third input comprises a third auxiliary output for coupling to the source of first additive.

6. A system according to claim 1, wherein the mixing section comprises a mixer, optionally an inline mixer.

7. A system according to claim 1, wherein:
(i) the mixing section is coupled directly to the blender; or
(ii) the system comprises an intermediate section and the mixing section is coupled to the intermediate section and the intermediate section is coupled to the blender.

8. A system according to claim 1, wherein:
(i) the first input is coupled directly to the blender; or
(ii) the system comprises an intermediate section and the first input is coupled to the intermediate section and the intermediate section is coupled to the blender.

9. A system according to claim 7, wherein the intermediate section is configured to combine the fuel from the first input and the aqueous phase from the mixing section at a combining point; optionally wherein the distance from the combining point to the blender is less than about 0.1 m; optionally less than about 0.05 m or less than about 0.01 m

10. A system according to claim 1, wherein the blender is a milling machine, a mixing machine, or a homogeniser.

11. A system according to claim 1, wherein the system comprises an output for coupling to an engine of a vehicle; optionally wherein the output is an output of the blender or is coupled to an output of the blender.

12. A system according to claim 11, wherein:
(i) the output is for coupling directly to the engine; or
(ii) the system comprises an intermediate output section for coupling to the engine of a vehicle and the output is coupled to the intermediate output section.

13. A system according to claim 12, wherein the intermediate output section comprises a first container having an internal volume from about 10 litres to about 40000 litres.

14. A system according to claim 13, wherein the first container comprises a first container output for coupling to the engine of a vehicle; optionally wherein the first container output is coupled to one or more of the intermediate section, the blender, the output, the first container, and/or the intermediate output section.

15. A system according to claim 12, wherein the intermediate output section comprises a second container having an internal volume from about 1 litre to about 100 litres; optionally wherein the second container comprises a second container output that is coupled to one or more of the intermediate section, the blender, the output, and/or the intermediate output section.

16. A system according to claim 12, wherein the intermediate output section comprises one or more flow directors that are configured to allow a flow of fluid from the blender to be provided to the first container and/or the second container.

17. A system according to claim 1, wherein the system comprises a fourth input for coupling to a source of second additive, and coupled to the mixing section.

18. (canceled)

19. (canceled)

20. (canceled)

21. A system according to claim 1, wherein the system comprises one or more controllers configured to receive an output from one or more of a flow regulator, blender, mixer, pump, heater, viscometer, and/or particle size analyser and output a controlling signal to one or more of a flow regulator, blender, mixer, pump, heater, viscometer, and/or particle size analyser.

22. A system according to claim 1, wherein the vehicle is a vessel, optionally a marine vessel.

23. A vehicle comprising the system according to claim 1, optionally wherein the vehicle is a vessel.

24. (canceled)

25. A process of forming an oil-in-water emulsion using the system according to claim 1.
